(19) United States
(12) Patent Application Publication
(10) Pub. No.: US 2004/0143550 A1
(43) Pub. Date: Jul. 22, 2004

(54) Cellular electronic wallet device and method

(75) Inventors: Thomas E. Creamer, Boca Raton, FL (US); Neil A. Katz, Parkland, FL (US); Victor S. Moore, Boynton Beach, FL (US); Scott L. Winters, Austin, TX (US)

Correspondence Address: AKERMAN SENTERFITT, P. O. BOX 3188, WEST PALM BEACH, FL, 33402-3188, US

(73) Assignee: International Business Machines Corporation, Armonk, NY

(21) Appl. No.: 10/324,537

(22) Filed: Dec. 19, 2002

(51) Int. Cl. G06F 17/60

(52) U.S. Cl. 705/41

(57) ABSTRACT

A method of conducting commerce within a portable, wireless computing device can include storing an identifier specifying a cellular communications channel and receiving a user input specifying financial transaction information. The identifier and the financial transaction information can be provided to a receiving device over a short range, wireless communications link to initiate the financial transaction. An authorization code can be received via the cellular communications channel specified by the identifier. The authorization code can indicate whether the financial transaction was approved.

### BACKGROUND OF THE INVENTION

1. Technical Field

The invention relates to the field of wireless communications devices and, more particularly, to using a wireless communications device to initiate and perform financial transactions.

2. Description of the Related Art

Electronic wallets allow consumers to more easily conduct commerce over computer networks such as the Internet and/or the Web. Conventional electronic wallets can be implemented as nothing more than an application configured to manage associations of account numbers, passwords, and user information which can be automatically inserted into appropriate fields of a browser rendered markup language document. Such electronic wallet applications provide limited functionality which typically is constrained to “filling in” data for a user in an effort to spare the user from having to tediously enter the same personal information each time the user makes an online purchase.

While many electronic wallet applications execute within conventional desktop or laptop computer systems, one variety of electronic wallet application can be implemented within a portable computing device having a display screen. Conventional electronic wallet devices can be programmed to present bar codes upon the display screen of the device. These conventional electronic wallet devices store and display, responsive to a user request, any of several different, static bar codes which correspond to identification cards the user typically carries on his or her person. The electronic wallet relieves the user from carrying an assortment of cards.

Standalone electronic wallet devices of the variety described above, however, typically do not incorporate any significant intelligence. That is, such devices merely store preprogrammed or static bar codes. The user can select an account, for example at the point of sale so that the electronic wallet device recalls the bar code associated with the user selected account and presents the bar code upon the display screen of the device. A bar code reader then can be read account information represented by the bar code.

Another class of electronic wallets can be implemented within wireless devices such as cellular or wireless telephone (cellular telephone). Depending upon the implementation of the electronic wallet application, however, much of the functionality of the cellular telephone may not be necessary, and therefore, serves only to add overhead to the electronic wallet design. For example, because cellular telephones support long range, two-way communications, the devices must include relatively sophisticated components. A cellular telephone incorporates both a wireless transmitter and a wireless receiver. Accordingly, an antenna duplexer also is included in the design to isolate the transmitter from the receiver channels which are separated by some frequency difference referred to as a split.

Wireless telephones further incorporate software for initiating outgoing calls and messaging. More particularly, the wireless telephone utilizes a control channel for call setup and messaging. The control channel is a two-way, packet-based channel which relies upon packet retransmission to recover lost packets. As noted, any component which is not utilized by the electronic wallet application can be viewed as nothing more than unnecessary overhead and a waste of resources. Accordingly, such components can needlessly and significantly increase the physical size, power consumption, and cost of designing and manufacturing an electronic wallet design that is implemented using cellular telephone hardware as a foundation.

### SUMMARY OF THE INVENTION

The present invention provides a method, system, and apparatus for conducting financial transactions using a portable computing device. More particularly, the present invention allows users to purchase goods and services using an electronic wallet device which does not require conventional presentation of a credit card or other item with account numbers or identifying information imprinted thereupon. Rather, the present invention provides increased security for financial transactions as information is not passed between the wireless electronic wallet, the merchant system, or the financial institution or authorization entity in a human readable format. Still, the present invention can include the use of personal identification numbers and/or encrypted wireless communications to provide enhanced security.

One aspect of the present invention can include a method of conducting commerce within a portable, wireless computing device. The method can include, within the portable, wireless computing device, storing an identifier specifying a cellular communications channel. A user input specifying financial transaction information can be received. The identifier and the financial transaction information can be provided to a receiving device over a short range, wireless communications link to initiate the financial transaction. Accordingly, an authorization code can be received via the cellular communications channel specified by the identifier. The authorization code can indicate whether the financial transaction was approved. A user of the portable, wireless computing device can be notified of the status of the financial transaction by displaying a visual notification or playing an audio notification.

According to one embodiment of the present invention, the providing step can include dynamically generating one or more graphic symbols specifying the identifier and the financial transaction information and presenting the graphic symbol upon a display screen of the portable, wireless computing device to be read by a bar code reader. A second graphic symbol can be generated which represents the authorization code. The second graphic symbol can be presented upon the display screen of the portable, wireless computing device to be read by the bar code reader.

In another embodiment of the present invention, the providing step can include establishing a short range, radio communications link and sending a message specifying the identifier and the financial transaction information over the short range, radio communications link. A second message can be sent which specifies the authorization code over the short range, radio communications link.

Another aspect of the present invention can include a method of performing a financial transaction within a point of sale system. The method can include receiving from a portable, wireless computing device a communication specifying an identifier and financial transaction information, wherein the identifier specifies a cellular communications channel. A financial institution can be identified from the financial transaction information. A communications link can be established with the financial institution to request approval of the financial transaction. A second communication can be received from the portable, wireless computing device which indicates whether the financial transaction was approved.

In one embodiment, the step of receiving from a portable, wireless computing device a communication can include reading a graphic symbol from a display of the portable, wireless computing device and determining the identifier and the financial transaction information from the graphic symbol. The step of receiving a second communication can include reading a second graphic symbol from a display of the portable, wireless computing device, determining whether the financial transaction was approved from the second graphic symbol, and concluding the financial transaction according to the step of determining whether the financial transaction was approved.

In another embodiment, the step of receiving from a portable, communication device a communication can include establishing a short range, radio communications link and receiving the communication specifying the identifier and the financial transaction information over the short range, radio communications link. The step of receiving a second communication can include receiving the second communication from the portable, wireless computing device over the short range, radio communications link, determining whether the financial transaction was approved, and concluding the financial transaction according to the step of determining whether the financial transaction was approved.

Another aspect of the present invention can include a method of clearing a financial transaction within an information processing system. The method can include receiving from a merchant point of sale system a communication specifying an identifier and financial transaction information, wherein the identifier specifies a cellular communications channel. An account for use in processing the financial transaction can be identified from the financial transaction information and the financial transaction can be processed with respect to the account. The cellular communication channel specified by the identifier can be established with a portable, wireless computing device and a communication can be sent to the portable, wireless computing device over the cellular communications channel. The communication can indicate whether the financial transaction was approved.

Another aspect of the present invention can include a portable, wireless computing device. The device can include a processor configured to dynamically generate graphic symbols according to user specified financial transaction information and received cellular communications. The device can include a memory configured to store an identifier specifying a cellular communications channel over which the cellular communications can be received as well as a cellular receiver coupled to an antenna. The cellular receiver and antenna can be tuned to receive cellular communications over the specified cellular communications channel. The device also can include a display screen configured to present graphic symbols dynamically generated by the processor. The device further can include one or more activatable buttons for specifying the financial transaction information.

In another embodiment of the present invention, the device can include a short range wireless transceiver configured to exchange short range communications specifying financial transaction information with a point of sale transaction processing system. In that case, the processor can be configured to dynamically generate the short range communications according to user specified financial transaction information and control the transmission of the short range communications via the short range wireless transceiver.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating a system for performing financial transactions in accordance with the inventive arrangements disclosed herein.

FIG. 2 is a schematic diagram illustrating a wireless electronic wallet device configured according to the present invention.

FIG. 3 is a flow chart illustrating a method of conducting a financial transaction using one embodiment of the device of FIG. 2.

FIG. 4 is a flow chart illustrating another method of performing a financial transaction using an alternative embodiment of the device of FIG. 2.

### DETAILED DESCRIPTION OF THE INVENTION

The present invention provides a method, system, and apparatus for conducting financial transactions using a wireless, portable computing device. More particularly, the present invention allows users to purchase goods and services using a wireless electronic wallet device. The device can communicate with merchant point of sale systems using a variety of communication techniques to initiate a financial transaction. The device further can receive communications from a financial institution to authorize a transaction pursuant to a merchant transaction processing system inquiry for approval to charge a user account.

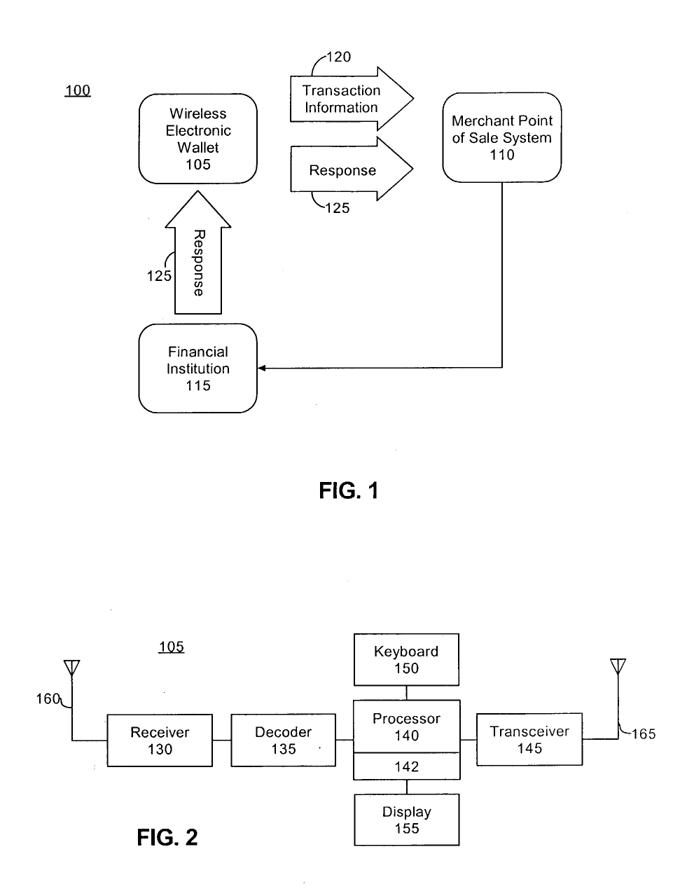

FIG. 1 is a schematic diagram illustrating a system 100 for performing financial transactions in accordance with the inventive arrangements disclosed herein. As shown, the system 100 can include a wireless electronic wallet 105, a merchant point of sale system (merchant system) 110, and a financial institution 115. The wireless electronic wallet 105 can be a portable, wireless computing device which can execute an electronic wallet application.

In operation, the wireless electronic wallet 105 can receive a request from a user to initiate a financial transaction such as a purchase of goods or services, for example while at a check-out or point of sale. Accordingly, the wireless electronic wallet 105 can provide transaction information 120 to the merchant point of sale system 110. The transaction information can include, but is not limited to, financial transaction information and device specific information. The financial transaction information can include, but is not limited to, an amount of the transaction and a personal identification number (PIN) which identifies the user. Financial transaction information also can include a secure code which, when used in combination with the PIN, can uniquely identify a user to the financial institution. The secure code can be assigned by the user's financial institution or a transaction authorization entity and, as such, can identify the user's financial institution. Notably, the secure code can be stored within the wireless electronic wallet 105.

The device specific information, which can be stored within the wireless electronic wallet 105, can include, but is not limited to, information specifying a communications channel over which the electronic wallet 105 can be reached. Depending upon the particular embodiment of the wireless electronic wallet 105, the transaction information 120 can be provided as a short range wireless transmission or as a bar code which can be displayed upon the display screen of the wireless electronic wallet 105.

The term “bar code” as used herein, can include any of a variety of graphic symbols or visual images. The bar code can be formed from an ordering of spaced vertical bars, wherein both the thickness of the bars and the amount of space between the bars can vary. The arrangement of bars and spacing specifies encoded information. For example, the bar code can be a conventional low, medium, or high density bar code. The bar code, however, also can be a single dimension, dual dimension and/or multidimensional bar code. Still, the bar code need not be formed of bars and spaces at all, but rather any image which can be read or interpreted using scanning technology as is typically utilized in “bar code” reading devices. Although a variety of existing bar code encoding standards exist, a bar code can specify information, whether numbers, characters, and/or symbols, using any protocol which both the bar code reader, and decoder if separate from the bar code reader, and the bar code generating device have been configured or programmed to implement.

The merchant point of sale system 110, using the transaction information 120, can identify parameters of the transaction information such as the amount a consumer is to pay, the identity of the financial institution 115 which manages the user account or the entity which provides transaction authorization, as well as information specifying the communications channel over which the wireless electronic wallet 105 can be contacted. Accordingly, the merchant point of sale system 110 can contact the financial institution 115 to obtain authorization to proceed with the transaction. Notably, the transaction information can specify contact information for the financial institution 115. Alternatively, the merchant point of sale system 110 can perform a data lookup to determine contact information once the identity of the financial institution 115 has been established.

The merchant point of sale system 110 can contact the financial institution 115 using any of a variety of communications techniques. For example, the merchant point of sale system, or an information processing system attached thereto, can communicate with the financial institution via a modem using a landline telephony connection or via a wireless communications link. Once a communications link has been established, the merchant point of sale system 110 can provide the financial institution 115 with the information specifying which communication channel can be used to contact the wireless electronic wallet 105. The merchant point of sale system 110 also can provide other parameters of the transaction information such as the amount of the transaction, the user's PIN, and the secure code.

The financial institution 115 can send a response 125 specifying an authorization code over a wireless communications channel specified by the information received from the merchant point of sale system 110. The wireless electronic wallet 105 can receive the response 125. Having received the response 125, the wireless electronic wallet 105 can forward the response 125 and/or the authorization code specified therein to the merchant point of sale system 110 to complete the financial transaction.

FIG. 2 is a schematic diagram illustrating the wireless electronic wallet 105 of FIG. 1. The wireless electronic wallet 105 can be configured to initiate and conduct financial transactions in accordance with the inventive arrangements disclosed herein. As shown in FIG. 2, the wireless electronic wallet 105 can include a receiver 130, a decoder 135, a processor 140, and a wireless transceiver 145. The wireless electronic wallet 105 also can include a receiving antenna 160 as well as an antenna 165 for use with the wireless transceiver 145.

The receiver 130 can be a long range wireless receiver, for example a receiver tuned to receive wireless communications within the cellular, Personal Communications. Services (PCS), or other frequency range which has been reserved or is suited to long range communications (collectively “cellular”). Accordingly, the antenna 160 can be communicatively linked to the receiver 130. The antenna 160 can be tuned or configured to operate or receive frequencies within the same frequency range for which the receiver 130 has been tuned.

The decoder 135, which is communicatively linked to the receiver 130 can decode signals received by the receiver 130. The decoder 135 can perform several functions including, but not limited to, correcting errors and controlling the receiver 130, for example to extend the life of the power supply (not shown) of the wireless electronic wallet 105. The decoder 135 further can analyze signals received by the receiver 130 to determine address information from the data stream.

Using the address information, the decoder 135 can determine whether a received signal is intended for the wireless electronic wallet 105 or another device. More particularly, the wireless electronic wallet 105 can be configured to respond only to a particular communications channel. Accordingly, the decoder 135 can be programmed or store channel information which specifies the particular cellular communications channel over which the wireless electronic wallet 105 will receive cellular communications. For example, the channel information can be a code or other identifier specific to the wireless electronic wallet 105.

The processor 140 can be a microprocessor or other controller which can include a memory store 142. Notably, the memory store 142 need not be “on-chip”, but rather can be a separate memory store. An application can be included within the memory store 142 such that the processor 140 can execute the application. The processor 140, can control the various components of the wireless electronic wallet 105, for example the receiver 130, the decoder 135, and the transceiver 145, as dictated by the application executing therein.

The processor 140 can be communicatively linked to the decoder 135, the transceiver 145, the keyboard 150, and the display 155 via suitable electronic circuitry or a communications bus. Accordingly, the processor 140 can receive information or a data stream from the decoder 135 as well as send information to the transceiver 145. The processor 140 also can detect input signals from the keyboard 150 and provide signals to the display 155 for presenting information thereupon.

The keyboard 150 can include one or more keys as well as scroll type or rotary knobs, which allow a user to provide user specified information such as PIN's and the like. Accordingly, the keyboard 150 can include various alphanumeric keys and/or special functions keys. For example, the keyboard 150 can be a small or miniature Qwerty style keyboard. The display 155 can be a liquid crystal display (LCD) screen or any other display screen which is suitable for use in a portable computing device. The display 155 can display or present bar codes which may be read by a bar code reader.

The transceiver 145 can be a short range wireless transceiver, which is communicatively linked to the antenna 165. The transceiver 145 and the antenna 165 can be tuned for sending and receiving wireless transmissions over a short range wireless communications channel. For example, the transceiver 145 and the antenna 165 can be configured to conduct wireless communications using Bluetooth and/or one of the 802.11 family of wireless communications protocols.

According to one aspect of the present invention, the transceiver 145 and the antenna 165 need not be included. In that case, the wireless electronic wallet 105 can be configured to provide information via the display 155 rather than via short range wireless transmissions.

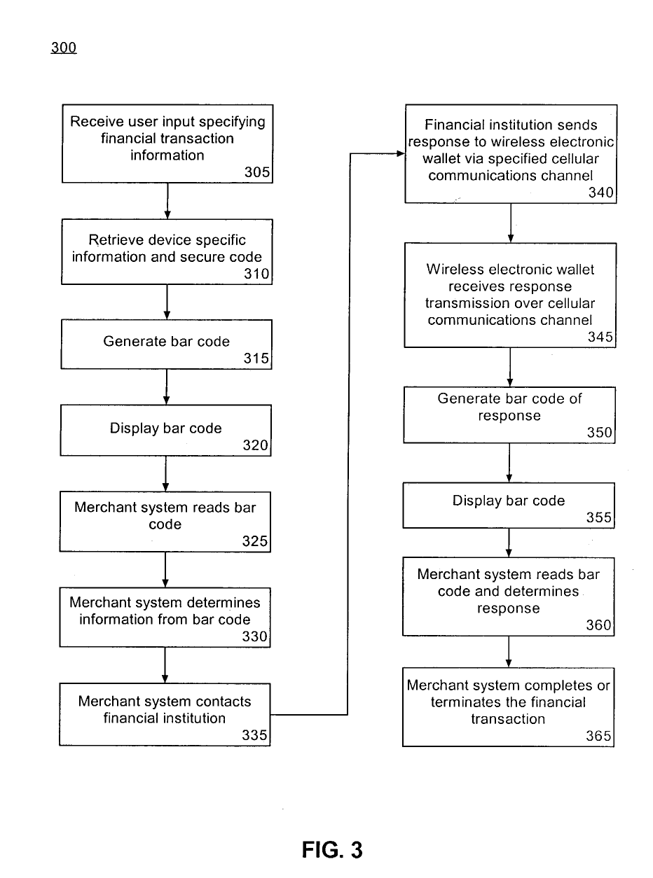

FIG. 3 is a flow chart illustrating a method 300 of conducting a financial transaction using the device of FIG. 2. The method 300 can begin in a state wherein the wireless electronic wallet has been activated and is executing an application program as previously noted. The method 300 illustrates an aspect of the present invention wherein information can be provided to the merchant system from the wireless electronic device by displaying bar codes. Accordingly, the transceiver and antenna for conducting short range wireless communications discussed with reference to FIG. 2 need not be included.

In step 305, a user input specifying financial transaction information can be received by the wireless electronic wallet. For example, the user can initiate a request via the controls of the wireless electronic wallet which can cause the application program to prompt the user for information such as the amount of the financial transaction, a PIN, and the like. If the wireless device is so configured, then user inputs can be received as speech inputs which can be speech recognized. Alternatively, a user can utilize the wireless electronic wallet keyboard or a pointer to activate controls upon a display screen.

In step 310, the wireless electronic wallet can retrieve device specific information which is stored within the device as well as the secure code. More particularly, the wireless electronic wallet can retrieve the identifier which specifies the particular cellular communication channel over which the wireless electronic wallet can receive wireless transmissions. In step 315, under the direction of the application program, the wireless electronic wallet can generate a bar code. The bar code can represent the user specified financial transaction information such as the PIN and the transaction amount.

Notably, the bar code also can represent or specify other information which is stored within the wireless electronic wallet. More particularly, the bar code can represent the identifier which specifies the communications channel over which the wireless electronic wallet can receive cellular communications as well as the secure code.

In one embodiment, the wireless electronic wallet can be configured to work with a particular user account. Accordingly, the secure code further can identify that account. Still, the wireless electronic wallet can be configured to function with several different accounts. In that case, the application executing within the device can prompt the user for the particular account to be used for the ongoing financial transaction. Accordingly, the user specified account information also can be included or represented by the bar code as part of the financial transaction information.

In step 320, the bar code can be presented upon the display of the wireless electronic wallet. Accordingly, a user can present the wireless electronic wallet at a check-out or other point of sale system equipped with a bar code reader. In step 325, the merchant system, that is a point of sale system, an information processing system, or any other system which can function as described herein and is equipped with a bar code reader, can read the bar code from the display of the wireless electronic wallet.

The merchant system can decode and/or determine the information specified from the bar code in step 330. Thus, the merchant system can identify the amount of the financial transaction, the PIN, the secure code, as well as the designated cellular communications channel. The merchant system also can identify the financial institution to be contacted to obtain approval for the transaction and an account if specified. By receiving the aforementioned data, the merchant system can verify that the user has requested or initiated a transaction for the correct monetary amount.

Although the merchant system can identify user information for purposes of forwarding the information to the financial institution, this is not to say that the merchant system can store or actually understand and read the user's financial information. Rather, the information can be passed on to the financial system for approval without scrutiny or analysis. The present invention provides increased security for financial matters as a human being need not ever see an account number in human readable form as the information passes to the merchant system via a bar code.

In step 335, the merchant system can contact the financial institution identified by the information deciphered from the bar code. Accordingly, the merchant system can provide information such as the cellular communication channel identifier, the amount, the PIN, and the secure code to the financial institution. In addition to determining whether sufficient funds are available, the financial institution can compare the received PIN with the secure code to authenticate the user.

After the financial institution has processed the received information to either authorize or decline the requested transaction, the financial institution can identify the cellular communications channel over which the wireless electronic wallet can be contacted. Accordingly, in step 340, a response can be sent to the wireless electronic wallet via the cellular communications channel. The financial institution response can indicate either that the financial transaction has been approved or declined.

In step 345, the wireless electronic wallet can receive the response transmission. Accordingly, the wireless electronic wallet can provide an indication to the user, whether an audio prompt or a text message upon the display screen, that the transaction has been approved or declined. For example, a different audio message can be played when the transaction is approved than when declined. Alternatively, so as not to needlessly embarrass a user when a transaction is declined, the same tone can be played and the device can provide a text message indicating the status of the financial transaction.

In step 350, after determining that the transmission was intended for the wireless electronic wallet and any necessary decoding of the received response transmission, a second bar code can be generated which represents the financial institution response. In step 355, the second bar code can be presented upon the display of the wireless electronic wallet. Thus, in step 360, the merchant system can read and decode the second bar code to determine the financial institution response. In step 365, if the second bar code indicates that the financial transaction has been authorized, the merchant system can complete the transaction. If, however, the second bar code indicates that the financial transaction has been declined, the merchant system can terminate the financial transaction without completion.

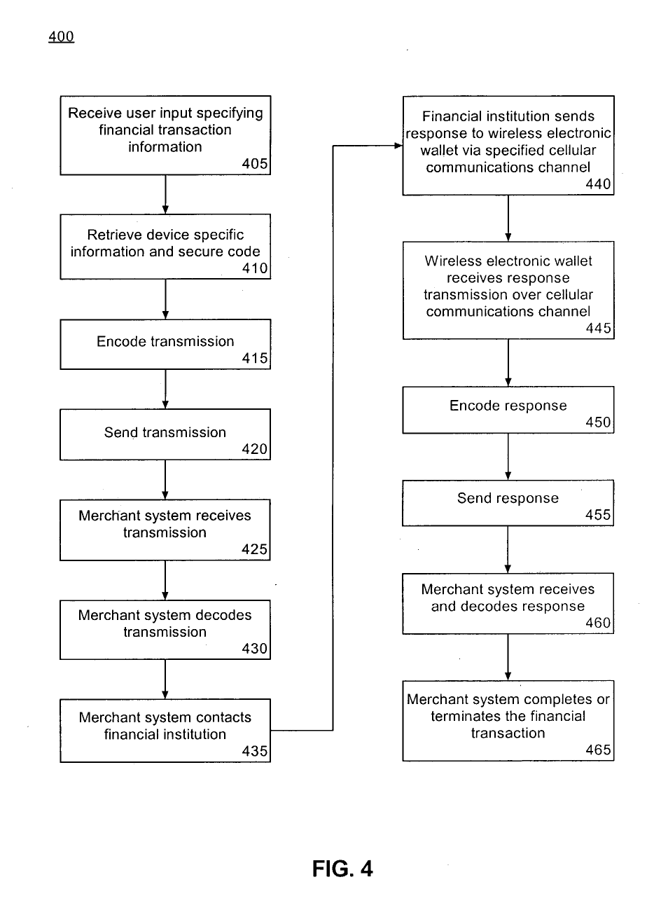

FIG. 4 is a flow chart illustrating another method 400 of performing a financial transaction using the device of FIG. 2. The method 400 operates in substantially the same manner as the method of FIG. 3, with the exception that method 400 illustrates an aspect of the present invention wherein the wireless electronic wallet communicates with merchant systems using the short range wireless transceiver rather than by presenting bar codes upon a display screen of the device.

In step 405, a user input specifying transaction information can be received within the wireless electronic wallet. In step 410, the wireless electronic wallet can retrieve device specific information such as the identifier specifying the cellular communications channel over which the wireless electronic wallet can receive wireless transmissions as well as the secure code.

In step 415, a message can be encoded which specifies the user specified financial transaction information as well as the secure code and the identifier. The message can be sent to the merchant system over the short range wireless communications link in step 420. As noted, the short range wireless communications link can be a Bluetooth communications link, an 802.11 communications link, or other suitable wireless communications link for communicating over short distances.

In step 425, the merchant system can receive the message from the wireless electronic wallet. In step 430, the merchant system can decode the received message to extract or determine the user specified transaction information as well as the device specific information. As noted, using the secure code, the merchant system can identify the user's financial institution or transaction authorization entity. Thus, in step 435, the merchant system can contact the financial institution.

The financial institution, having received the financial transaction information as well as the information needed to contact the wireless electronic wallet and the secure code, can either approve or decline the financial transaction. Accordingly, in step 440, the financial institution can send a response transmission to the wireless electronic wallet via the cellular communication channel over which the wireless electronic wallet can receive transmissions. In step 445, the wireless electronic wallet can receive the response transmission over the cellular communications channel.

In step 450, the wireless electronic wallet can encode the received financial institution response and, in step 455, send the response to the merchant system via the short range wireless communications link. In step 460, the merchant system can receive the encoded response over the short range wireless communications link and decode the response. The merchant system then can either complete the financial transaction or terminate the financial transaction in accordance with the received financial institution response.

Although this embodiment of the present invention was described with reference to a short range, radio-frequency communications channel over which the merchant system and the wireless electronic wallet can communicate, one skilled in the art will recognize that other communications channels can be used. For example, the wireless electronic wallet and the merchant system can utilize matched infrared transceivers or sound-wave transceivers.

In any case, this embodiment of the present invention supports two-way communications between the merchant system and the wireless electronic wallet, thereby allowing the merchant system to provide additional information to the wireless electronic wallet before, during, or after the financial transaction. For example, the merchant system can send marketing materials such as coupons or an indication that the transaction has been fully processed. Accordingly, the wireless electronic wallet can beep or display a message indicating to the user that the financial transaction has been completed or one which relays the promotional and/or marketing materials to the user.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. Within a portable wireless computing device, a method of conducting a financial transaction comprising:
storing within the portable, wireless computing device an identifier specifying a cellular communications channel;
receiving a user input specifying financial transaction information;
providing the identifier and the financial transaction information to a receiving device over a short range, wireless communications link to initiate the financial transaction; and
receiving an authorization code via the cellular communications channel specified by the identifier, wherein the authorization code indicates whether the financial transaction was approved.

2. The method of claim 1, further comprising:
notifying a user of a status of the financial transaction by displaying a visual notification or playing an audio notification.

3. The method of claim 1, said providing step comprising:
dynamically generating at least one graphic symbol specifying the identifier and the financial transaction information; and
presenting the graphic symbol upon a display screen of the portable, wireless computing device to be read by a bar code reader.

4. The method of claim 3, further comprising:
generating a second graphic symbol representing the authorization code; and
presenting the second graphic symbol upon the display screen of the portable, wireless computing device to be read by the bar code reader.

5. The method of claim 1, said providing step comprising:
establishing a short range, radio communications link; and
sending a message specifying the identifier and the financial transaction information over the short range, radio communications link.

6. The method of claim 5, further comprising:
sending a second message specifying the authorization code over the short range, radio communications link.

7. In a point of sale system, a method of performing a financial transaction comprising:
receiving from a portable, wireless computing device a communication specifying an identifier and financial transaction information, wherein the identifier specifies a cellular communications channel;
identifying a financial institution from the financial transaction information;
establishing a communications link with the financial institution to request approval of the financial transaction; and
receiving a second communication from the portable, wireless computing device indicating whether the financial transaction was approved.

8. The method of claim 7, said step of receiving from a portable, wireless computing device a communication further comprising:
reading a graphic symbol from a display of the portable, wireless computing device; and
determining the identifier and the financial transaction information from the graphic symbol.

9. The method of claim 8, said step of receiving a second communication comprising:
reading a second graphic symbol from a display of the portable, wireless computing device;
determining whether the financial transaction was approved from the second graphic symbol; and
concluding the financial transaction according to the step of determining whether the financial transaction was approved.

10. The method of claim 7, said step of receiving from a portable, communication device, a communication further comprising:
establishing a short range, radio communications link; and
receiving the communication specifying the identifier and the financial transaction information over the short range, radio communications link.

11. The method of claim 10, said step of receiving a second communication further comprising:
receiving the second communication from the portable, wireless computing device over the short range, radio communications link;
determining whether the financial transaction was approved from the second communication; and
concluding the financial transaction according to the step of determining whether the transaction was approved.

12. A method of clearing a financial transaction within an information processing system comprising:
receiving from a merchant point of sale system a communication specifying an identifier and financial transaction information, wherein the identifier specifies a cellular communications channel;
identifying an account for use in processing the financial transaction from the financial transaction information;
processing the financial transaction with respect to the account;
establishing the cellular communications channel specified by the identifier with a portable, wireless computing device; and
sending a communication to the portable, wireless computing device over the cellular communications channel, wherein the communication indicates whether the financial transaction was approved.

13. A portable, wireless computing device comprising:
a processor configured to dynamically generate graphic symbols according to user specified financial information and received cellular communications;
a memory configured to store an identifier specifying a cellular communications channel over which the cellular communications can be received;
a cellular receiver coupled to an antenna and tuned to receive cellular communications over the specified cellular communications channel; and
a display screen configured to present graphic symbols dynamically generated by said processor.

14. The portable, wireless computing device of claim 13, further comprising:
at least one activatable button for specifying the financial information.

15. The portable, wireless computing device of claim 13, further comprising:
a decoder configured to process signals received via said cellular receiver.

16. A portable, wireless computing device comprising:
a memory configured to store an identifier specifying a cellular communications channel over which cellular communications can be received;
a cellular receiver coupled to an antenna and tuned to receive communications over the specified cellular communication channel;
a short range wireless transceiver configured to exchange short range communications specifying financial transaction information with a point of sale transaction processing system; and
a processor configured to dynamically generate the short range communications according to user specified financial information and control the transmission of the short range communications via said short range wireless transceiver.

17. The portable, wireless computing device of claim 16, further comprising:
at least one activatable button for specifying the financial information.

18. The portable, wireless computing device of claim 16, further comprising:
a decoder configured to process signals received from said cellular receiver.

19. A machine readable storage, having stored thereon a computer program having a plurality of code sections executable by a portable, wireless computing device for causing the portable, wireless computing device to perform the steps of:
storing within the portable, wireless computing device an identifier specifying a cellular communications channel;
receiving a user input specifying financial transaction information;
providing the identifier and the financial transaction information to a receiving device over a short range, wireless communications link to initiate the financial transaction; and
receiving an authorization code via the cellular communications channel specified by the identifier, wherein the authorization code indicates whether the financial transaction was approved.

20. The machine readable storage of claim 19, further comprising:
notifying a user of a status of the financial transaction by displaying a visual notification or playing an audio notification.

21. The machine readable storage of claim 19, said providing step comprising:
dynamically generating at least one graphic symbol specifying the identifier and the financial transaction information; and
presenting the graphic symbol upon a display screen of the portable, wireless computing device to be read by a bar code reader.

22. The machine readable storage of claim 21, further comprising:
generating a second graphic symbol representing the authorization code; and
presenting the second graphic symbol upon the display screen of the portable, wireless computing device to be read by the bar code reader.

23. The machine readable storage of claim 19, said providing step comprising:
establishing a short range, radio communications link; and
sending a message specifying the identifier and the financial transaction information over the short range, radio communications link.

24. The machine readable storage of claim 23, further comprising:
sending a second message specifying the authorization code over the short range, radio communications link.

25. A machine readable storage, having stored thereon a computer program having a plurality of code sections executable by a portable, wireless computing device for causing the portable, wireless computing device to perform the steps of:
receiving from a portable, wireless computing device a communication specifying an identifier and financial transaction information, wherein the identifier specifies a cellular communications channel;
identifying a financial institution from the financial transaction information;
establishing a communications link with the financial institution to request approval of a financial transaction; and
receiving a second communication from the portable, wireless computing device indicating whether the financial transaction was approved.

26. The machine readable storage of claim 25, said step of receiving from a portable, wireless computing device a communication further comprising:
reading a graphic symbol from a display of the portable, wireless computing device; and
determining the identifier and the financial transaction information from the graphic symbol.

27. The machine readable storage of claim 26, said step of receiving a second communication comprising:
reading a second graphic symbol from a display of the portable, wireless computing device;
determining whether the financial transaction was approved from the second graphic symbol; and
concluding the financial transaction according to the step of determining whether the financial transaction was approved.

28. The machine readable storage of claim 25, said step of receiving from a portable, communication device, a communication further comprising:
establishing a short range, radio communications link; and
receiving the communication specifying the identifier and the financial transaction information over the short range, radio communications link.

29. The machine readable storage of claim 28, said step of receiving a second communication further comprising:
receiving the second communication from the portable, wireless computing device over the short range, radio communications link;
determining whether the financial transaction was approved from the second communication; and
concluding the financial transaction according to the step of determining whether the transaction was approved.

30. A machine readable storage, having stored thereon a computer program having a plurality of code sections executable by a portable, wireless computing device for causing the portable, wireless computing device to perform the steps of:
receiving from a merchant point of sale system a communication specifying an identifier and financial transaction information, wherein the identifier specifies a cellular communications channel;
identifying an account for use in processing a financial transaction from the financial transaction information;
processing the financial transaction with respect to the account;
establishing the cellular communications channel specified by the identifier with a portable, wireless computing device; and
sending a communication to the portable, wireless computing device over the cellular communications channel, wherein the communication indicates whether the financial transaction was approved.
